(19) United States
(12) Patent Application Publication
(10) Pub. No.: US 2026/0288506 A1
(43) Pub. Date: Sep. 24, 2026

(54) ORCHESTRATED AUXILIARY POD FRAMEWORK FOR ADDRESSING SCALING CHALLENGES IN DISTRIBUTED COMPUTING SYSTEMS

(71) Applicant: Hewlett Packard Enterprise Development LP, Spring, TX (US)

(72) Inventors: Pradeep Ganachari, Bangalore (IN); Tathagata Roy, Bangalore (IN); Sanjaya Kumar Sahoo, Bangalore (IN)

(21) Appl. No.: 19/257,812

(22) Filed: Jul. 2, 2025

(30) Foreign Application Priority Data
Mar. 18, 2025 (IN) 202541024156

(51) Int. Cl. G06F 9/455

(52) U.S. Cl. CPC G06F 9/45558; G06F 2009/45562; G06F 2009/4557; G06F 2009/45591

(57) ABSTRACT

According to an implementation, a computing system includes a processor and a non-transitory memory storing instructions that, when executed, enable dynamic resource management in distributed computing environments. The system monitors metrics associated with primary pods processing data from assigned partitions. Upon detecting a surge condition affecting a specific primary pod, rather than creating replica pods or modifying resource allocations, the system transforms the affected primary pod into an orchestrator while maintaining its partition connection. The orchestrator pod delegates processing tasks to newly created auxiliary pods through a database, enabling distributed processing without partition rebalancing.

### BACKGROUND

Distributed computing environments enable the processing of data across multiple interconnected systems. In these environments, computing nodes can host various processing components, including pods that contain one or more containers. These containers can share resources such as networking and storage within their respective computing nodes.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a schematic of an implementation distributed computing cluster;

FIG. 2 is a block diagram of an implementation horizontal pod autoscaling (HPA) in a distributed computing cluster;

FIG. 3 is a block diagram of an implementation vertical pod autoscaling (VPA) in a distributed computing cluster;

FIG. 4 is a block diagram of an implementation horizontally orchestrated auxiliary pod framework in a distributed computing cluster;

FIG. 5 is a flowchart of an implementation method for the horizontally orchestrated auxiliary pod framework of FIG. 4;

FIG. 6 is a sequence diagram showing an example interaction between components of the horizontally orchestrated auxiliary pod framework;

FIG. 7 is a flowchart of an implementation method for operations performed by a computing system processing data as a primary pod in a distributed computing environment;

FIG. 8 is a flowchart of an implementation method for operations performed by a computing system functioning as a controller in a distributed computing environment; and

FIG. 9 is a block diagram of an implementation computing system that can implement the primary pods, auxiliary pods, and controller components described herein.

### DESCRIPTION

The following disclosure provides many different examples for implementing different features. Specific examples of components and arrangements are described below to simplify the present disclosure. These are, of course, merely examples and are not intended to be limiting.

The particular implementations are merely illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the implementations are described primarily in the context of Kubernetes^{®} clusters processing message broker data through partition-aware pods, it should also be appreciated that these implementations may also apply to other distributed computing environments and data processing scenarios. In particular, aspects of the disclosure may similarly apply to cloud computing platforms, containerized applications in enterprise networks, microservices architectures, and any distributed system where computing resources process partitioned data streams or handle varying workload demands through scalable computing environments.

The implementations can be adapted for various types of data processing, including but not limited to API request handling, database operations, stream processing, event handling, and real-time analytics. The orchestrated worker or auxiliary pod framework can be integrated with different container orchestration platforms and support various communication protocols and data storage systems.

In distributed computing environments, computing nodes host multiple pods that process data from various sources. Each pod comprises one or more containers that share networking and storage resources within their respective computing node. The pods operate independently with specific resource allocations and can handle different workloads, including processing messages from message brokers, responding to API requests, or managing database operations. The pods can communicate through databases, allowing for data sharing and task distribution across the distributed computing environment.

Computing systems can implement auto-scaling mechanisms to handle varying levels of data processing demands. These mechanisms include horizontal scaling, which adjusts the number of pod replicas, and vertical scaling, which modifies the CPU and memory resources allocated to pods. In partition-aware implementations, specific pods can be assigned to process data from particular partitions, maintaining data consistency and enabling state-based processing operations.

When traffic surges occur, affected pods can be overwhelmed, particularly for partition-aware workloads where specific pods are assigned to handle particular data streams or message partitions. This can create a risk of system failure due to overload, leading to message processing delays or data loss. The situation can become critical when the surge affects only specific pods while others continue operating normally.

Conventional solutions like horizontal pod autoscaling (HPA) cannot effectively address partition-aware workloads since new pods cannot share the load from the same partition. Vertical pod autoscaling (VPA) requires killing and recreating all pods in a deployment, causing system downtime and requiring costly rebalancing operations.

In implementations, a horizontally orchestrated worker (i.e., auxiliary) pod framework enables dynamic resource management in distributed computing systems. The framework includes a controller that monitors metrics associated with primary pods processing data from assigned partitions. When the controller detects a surge condition affecting a specific primary pod, the controller creates auxiliary pods and instructs the affected primary pod to transform into an orchestrator.

Upon receiving transformation instructions from the controller, the primary pod transitions into an orchestrator mode while maintaining its connection to its assigned partition. In orchestrator mode, the primary pod receives data from its partition but generates processing tasks instead of directly performing them. The primary pod delegates these tasks to the auxiliary pods through a database, allowing for distributed processing without triggering partition rebalancing operations.

The auxiliary pods operate independently from the primary pod deployment, processing tasks received through the database. The auxiliary pods can scale up or down based on processing demands without affecting other primary pods in the system. When the surge condition subsides, the controller may remove the auxiliary pods and instruct the primary pod to exit orchestrator mode and resume normal processing operations.

The framework maintains system stability by avoiding pod termination and recreation during scaling operations. The solution preserves partition awareness while enabling targeted scaling for specific pods experiencing increased workloads. The database facilitates task distribution and completion tracking between the orchestrator pod and its auxiliary pods, enabling efficient workload management during surge conditions.

Accordingly, the proposed approach provides several advantages over conventional solutions: it eliminates system downtime since pods are not killed and recreated, avoids costly rebalancing operations, maintains partition awareness, and allows selective scaling only for affected pods without disrupting normally functioning ones. The framework enables more efficient resource utilization by creating worker pods only when and where needed rather than scaling entire deployments. These and additional details are further discussed below.

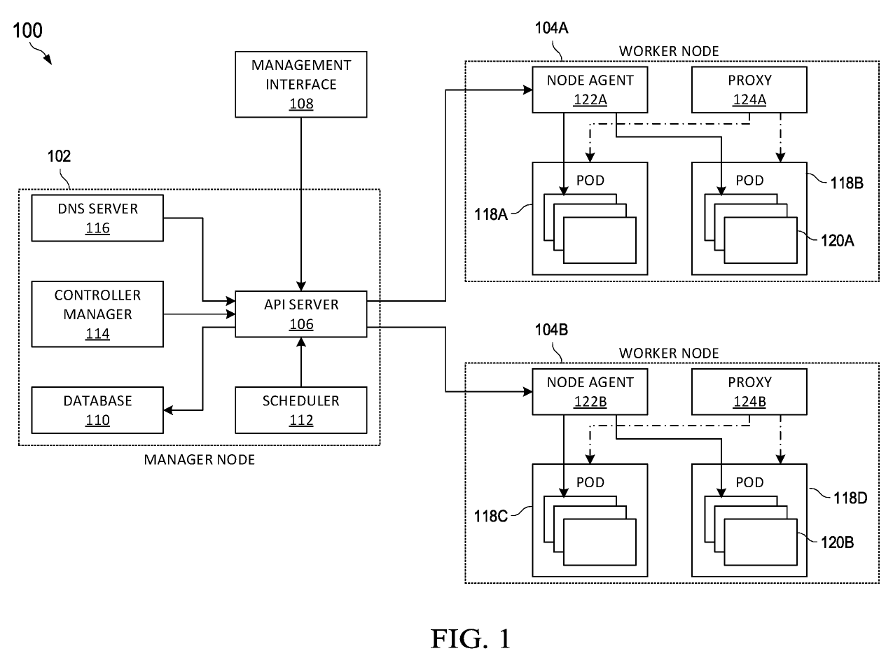

FIG. 1 illustrates a schematic of an implementation distributed computing cluster 100. The computing cluster 100 includes computing nodes, which may be physical computers, virtual machines, or containers. The computing nodes include a manager node 102, a first worker node 104A, and a second worker node 104B, which may (or may not) be arranged as shown. The computing cluster 100 may include additional components not shown, such as additional worker nodes and message brokers.

The manager node 102 monitors and manages resource allocation across the computing cluster 100. The worker nodes 104 (here shown as a non-limiting example, a first worker node 104A and a second worker node 104B) host pods 118 that process data, where pods can be assigned to specific data partitions for processing. Each worker node 104 includes a node agent 122 and a proxy 124 to manage pod operations. In an example implementation, the computing cluster 100 is a Kubernetes^{®} cluster.

The manager node 102 functions as the control plane for the computing cluster 100 and acts as the entry point for administrative tasks. The manager node 102 includes an API server 106 that provides internal and external interfaces to access the computing cluster 100. The API server 106 can receive commands from a management interface 108, which may be a command line interface tool. The commands may be representational state transfer (REST) command requests. The API server 106 processes the commands from the management interface 108, validates the commands and executes logic specified by the commands.

The results of the commands processed by the API server 106 may be stored in a database 110. The database 110 may be a distributed key-value data storage component, such as an etcd database, which may be included with the manager node 102. The database 110 can store configuration data of the computing cluster 100, representing the state of the computing cluster 100 (e.g., what pods exist, what pods should be running, which nodes the pods should be running on, resource utilization metrics, etc.). The database 110 can provide storage for the commands received by the API server 106 to perform create-read-update-and-delete (CRUD) operations and an interface to register watchers on specific nodes, thereby providing a reliable way to notify the rest of the computing cluster 100 about configuration changes.

The manager node 102 includes a resource scheduler 112 and a controller manager 114. The resource scheduler 112 is adapted to deploy pods onto the worker nodes 104. The resource scheduler 112 can include information regarding available resources on the computing cluster 100 and the resources utilized for the applications. This information can be used by the resource scheduler 112 to make decisions about where to deploy pods.

The controller manager 114 manages controllers of the computing cluster 100. The controller manager 114 can use the API server 106 to watch the state of one or more resource(s) and automatically make changes based on the resource(s) state. The controller manager 114 can implement different controllers to manage various aspects of pod lifecycle and scaling operations. In addition, the manager node 102 may include a DNS server 116, which serves DNS records for the components of the computing cluster 100.

The pods 118 run on each of the worker nodes 104. Containers 120 reside within the pods 118. Containers 120 are co-located on respective ones of the worker nodes 104, where the respective pods 118 are running and may share resources. A pod 118 is a containerized component group that shares resources such as storage, namespaces, control groups, and IP addresses. Each pod 118 is assigned an IP address within the computing cluster 100.

Containers 120 includes the minimum operating system resources, memory, and dependencies to run an application. Examples of the dependencies include files, environment variables, libraries, and the like. The host operating system for worker nodes 104 constrains access of container 120 to physical resources of worker nodes 104, such as CPUs, storage, memory, and the like. The worker nodes 104 may use virtualization to run the containers 120.

The pods 118 running on a worker node 104 are created, destroyed, and re-created based on the state of the computing cluster 100. To facilitate communication with pods 118, a service may be defined for certain pods 118 even when their IP addresses change. A service is an abstraction of a group of pods 118, typically using a proxy. A virtual IP address may be assigned to a service so that other components can communicate with the service. Load balancing may be set up for at least some of the pods 118 so that a pod 118 may be exposed via a service.

Each worker node 104 can include a node agent 122, which communicates with the manager node 102 and receives details for configuring the pods 118 from the API server 106. The node agent 122 uses the received details to ensure that containers 120 are constructed and running as intended.

Further, each worker node 104 can include a proxy 124, which functions as a network proxy through which requests are transferred and as a load balancer for a service on a worker node 104 to reverse proxy and distribute network traffic across containers 120. The proxies 124 can route traffic to the appropriate container 120 based on, for example, the service's virtual IP address.

To perform cluster operations, a deployment configuration that provides instructions on how to create and update components can be input to the manager node 102 via the management interface 108. Once the instructions are received, the API server 106 can schedule the cluster operation onto the worker nodes 104 to operate using a combination of multiple different components within multiple containers 120 of multiple different pods 118.

While the distributed computing cluster 100 is described concerning specific components and arrangements, this is just one example implementation. Other implementations are similarly contemplated where a manager node works with worker nodes to distribute computing across computing nodes hosting containers. The specific terminology, architectures, and arrangements may vary while maintaining the general principles of a distributed computing system where workloads are managed and distributed across multiple nodes.

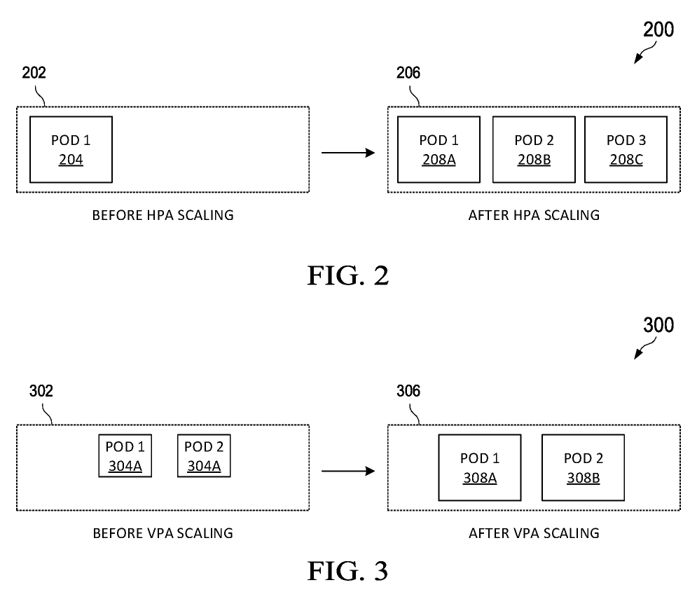

FIG. 2 illustrates a block diagram of an implementation horizontal pod autoscaling (HPA) 200 in a distributed computing cluster, such as the computing cluster 100 of FIG. 1. The figure shows a first deployment 202 with the state before HPA scaling, where a single pod (Pod 1) 204 processes data from its assigned workload. When the workload increases beyond a threshold, the system can transition through the autoscaling process to a second deployment 206, where a first pod (POD 1) 208A, a second pod (POD 2) 208B, and a third pod (POD 3) 208C share the processing load.

Horizontal Pod Autoscaling (HPA) automatically scales the number of pods in a deployment, replication controller, or replica set based on observed CPU utilization or other specified metrics. HPA creates additional pods to handle increased workload demands. This approach allows applications to scale out by adding more pods or reducing the number of pods in response to load changes, providing elasticity and cost efficiency through optimized resource usage.

In one or more implementations, the HPA process operates through continuously monitoring pod metrics via a metrics server. In implementations, the controller manager 114 of FIG. 1, acting as the HPA controller, evaluates current metric values against predefined thresholds and calculates the number of replicas to handle the workload. When monitored metrics exceed configured thresholds, the controller manager 114 can create additional pods within the deployment. These pods can share the same deployment configuration, enabling distributed workload processing. During periods of reduced load, the controller manager 114 can remove excess pods to optimize resource utilization.

However, HPA scaling presents limitations in partition-aware environments where specific pods are assigned to process data from particular partitions. When a pod is assigned to a specific partition, creating additional pods may not effectively address the increased workload since the new pods cannot share the processing load from the same partition. Additionally, in cases where the workload surge affects specific pods while others operate normally, HPA's approach of scaling the entire deployment may not provide the most efficient resource utilization. These limitations can become particularly evident in message broker implementations where partition awareness and state maintenance are critical for data processing operations.

While FIG. 2 shows scaling from a single pod to three pods as an example implementation, this is a non-limiting example. Other implementations may scale to fewer or greater numbers of pods based on workload demands, resource availability, and scaling parameters.

FIG. 3 illustrates a block diagram of an implementation vertical pod autoscaling (VPA) 300 in a distributed computing cluster, such as the computing cluster 100 of FIG. 1. The figure shows a first deployment 302 with the state before VPA scaling, where a first pod (POD 1) 304A and a second pod (POD 2) 304B process data with initial resource allocations. When resource utilization exceeds thresholds, the system can transition through the autoscaling process to a second deployment 306, where a first pod (POD 1) 308A and a second pod (POD 2) 308B operate with increased CPU and memory resource allocations.

Vertical Pod Autoscaling (VPA) automatically adjusts the resource requests (e.g., CPU and memory) and limits for existing pods in a deployment, replication controller, or replica set. Unlike HPA, which creates additional pods, VPA modifies the resources allocated to existing pods. This approach allows applications to optimize resource utilization by dynamically adjusting pod-level resources based on usage patterns.

In one or more implementations, the VPA process continuously monitors pod resource usage via a metrics server. In implementations, the controller manager 114 of FIG. 1, acting as the VPA controller, evaluates resource utilization patterns and recommends adjustments to pod specifications. When monitored metrics indicate sustained resource pressure, the controller manager 114 can modify the resource allocations for the affected pods. These modifications require pod restarts, as resource specifications cannot be changed for running pods.

VPA scaling can present limitations in environments with continuous data processing requirements. When pods need to be terminated and recreated to apply new resource allocations, this can cause processing interruptions and state loss. In partition-aware environments, these interruptions can be particularly problematic as they may require partition reassignment and rebalancing operations. Additionally, the pod restart requirement can impact service availability and may not be suitable for applications requiring high availability.

While FIG. 3 shows the scaling of two pods as an example implementation, this is a non-limiting example. Other implementations may apply vertical scaling to fewer or greater numbers of pods based on resource utilization patterns, available node capacity, and scaling parameters.

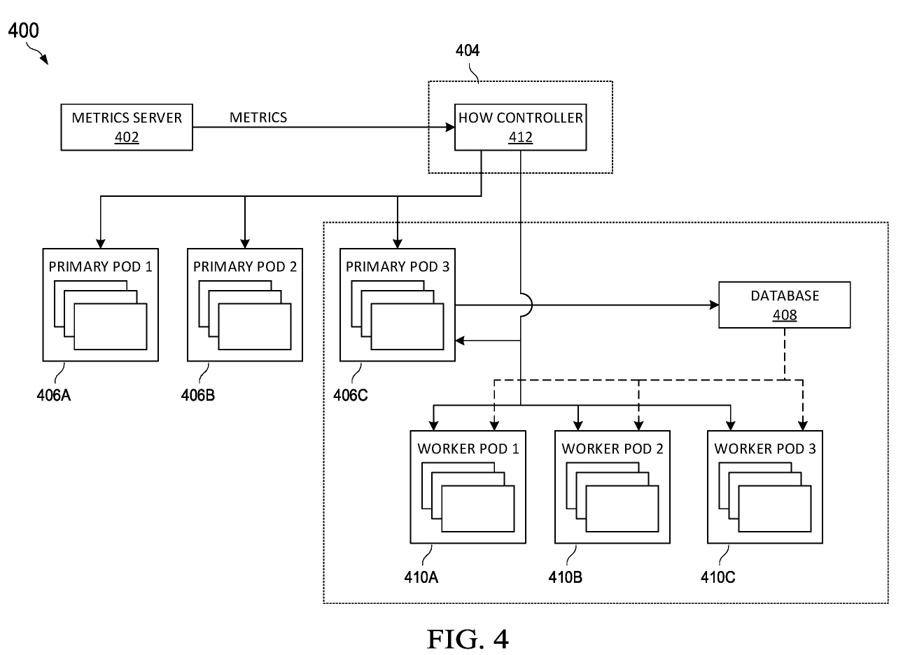

FIG. 4 illustrates a block diagram of an implementation horizontally orchestrated auxiliary pod framework 400 in a distributed computing cluster, such as the computing cluster 100 of FIG. 1. The horizontally orchestrated auxiliary pod framework 400 provides a scaling solution that addresses the limitations of traditional horizontal and vertical pod autoscaling approaches.

Traditional scaling approaches present significant limitations in partition-aware environments. Horizontal Pod Autoscaling (HPA) cannot effectively handle partition-specific load increases since new replica pods cannot share the processing load from the same partition. Vertical Pod Autoscaling (VPA) requires killing and recreating pods to adjust resource limits, causing processing interruptions, downtime, and costly partition rebalancing operations. These limitations can become particularly problematic in environments with continuous data processing requirements and strict partition awareness needs. The HOW framework eliminates downtime, mitigates rebalancing delays, and provides an efficient and adaptive solution to these limitations.

The horizontally orchestrated auxiliary pod framework 400 includes a metrics server 402, an auto scaler 404, primary pods 406A-C, a database 408, and auxiliary pods 410A-C, which may (or may not) be arranged as shown. The horizontally orchestrated auxiliary pod framework 400 may include additional components not shown, such as additional pods.

The metrics server 402 collects performance and resource utilization data from pods and infrastructure components. In implementations, the metrics server 402 uses a pull-based model, storing the collected metrics in, for example, an internal time-series database for analysis.

The database 408 maintains operational data for the horizontally orchestrated auxiliary pod framework 400, tracking task assignments, offsets, and processing progress between the orchestrator pod and auxiliary pods. The database 408 can be implemented using various solutions based on specific needs, such as Redis^{®}, Apache Kafka^{®}, or lightweight in-memory databases. In implementations, the database 408 serves as the central repository for maintaining the state of task distribution and completion status.

In implementations, when throughput exceeds defined thresholds for a primary pod, such as primary pod 406C, the HOW controller 412 of the auto scaler 404 initiates a transformation process. Instead of creating identical replicas as in traditional HPA or modifying resource allocations as in VPA, the HOW controller 412 transforms the affected primary pod 406C into an orchestrator role while maintaining its connection to its assigned partition.

Operating in orchestrator mode, primary pod 406C continues receiving data from its assigned partition but delegates processing tasks to auxiliary pods 410A-C. The primary pod 406C starts as a standard stateful processing pod (e.g., Apache Kafka^{®} consumer) and transforms into an orchestrator that exposes Application Programming Interfaces (APIs) (e.g., Google Remote Procedure Call (GRPC)/Representational State Transfer (REST) APIs). In implementations, the APIs serve two functions: (1) providing tasks to dynamically spawned auxiliary pods, and (2) tracking task progress and reporting metrics to the auto scaler.

The primary pod 406C, operating in the orchestrator mode, maintains the lifecycle of auxiliary pods and ensures tasks are distributed efficiently. The auto scaler 404, working with the HOW controller 412, dynamically creates the auxiliary pods 410 based on workload demands. The primary pod 406C, operating in the orchestrator mode, manages task distribution to auxiliary pods 410 through a database, which can be implemented using the optional database 408.

Auxiliary pods 410A-C receive (e.g., fetch) specific processing tasks or offsets from the primary pod 406C, operating in the orchestrator mode, process their assigned workloads, and report progress to the orchestrator. By assigning specific tasks or offsets to auxiliary pods, the framework avoids state redistribution overhead (for example, Kafka^{®} rebalancing operations) and maintains continuous message processing without disruptions. This approach eliminates the need for partition reassignment and rebalancing operations that typically occur in traditional scaling methods. When workload demands decrease, auxiliary pods 410A-C can be terminated to reduce resource usage, and the primary pod 406C, operating in the orchestrator mode, can revert to its original role as a primary pod (e.g., Kafka^{®} consumer).

In some implementations, the HOW controller 412 functions as the central control component of the framework, continuously monitoring metrics from the metrics server 402, analyzing workload patterns, and managing the lifecycle of auxiliary pods. In implementations, the HOW controller 412 manages the workpods through an API (e.g., Kubernetes^{®} API). The HOW controller 412 can utilize standard resource metrics or custom metrics, such as pending tasks, consumer lag (e.g., Kafka^{®} consumer lag), or partition load, accessed through, for example, the Kubernetes^{®} custom metrics API, monitoring systems, or a Kubernetes^{®} metrics server (e.g., Prometheus^{®}).

While FIG. 4 shows three primary pods and three auxiliary pods as an example implementation, this is a non-limiting example. Other implementations may employ different numbers of primary and auxiliary pods based on workload characteristics, resource availability, and scaling requirements. Additionally, the database 408 implementation can vary based on specific needs, ranging from in-memory solutions to distributed databases.

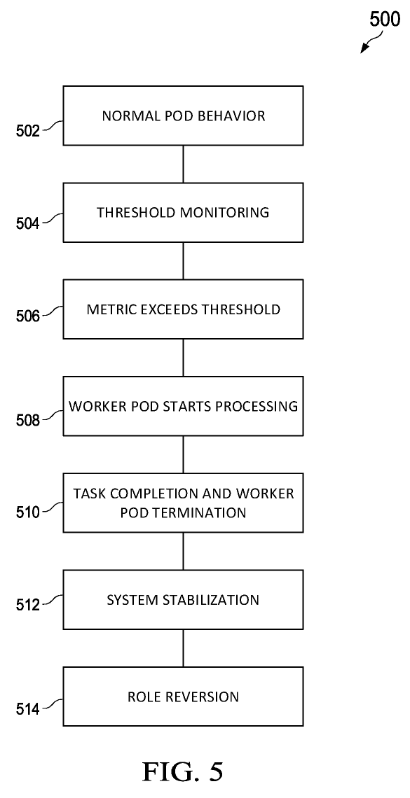

FIG. 5 illustrates a flowchart of an implementation method 500 for the horizontally orchestrated auxiliary pod framework 400 of FIG. 4. It is noted that all steps outlined in the method are not necessarily required and can be optional. Further, changes to the arrangement of the steps, removal of one or more steps and path connections, and addition of steps and path connections are similarly contemplated.

At step 502, during normal pod behavior, a primary pod operates as a consumer (e.g., Kafka^{®} consumer) and processes data from its assigned partition. The pod operates independently without orchestration or auxiliary pod involvement. In implementations, this can include a pod acting as a message broker consumer, processing messages from assigned partitions.

At step 504, the threshold monitoring phase involves continuous monitoring of pod metrics by the auto scaler. These metrics can include throughput measurements, resource utilization, or custom metrics specific to the implementation. For example, in a message broker implementation, metrics may include consumer lag or message processing rates.

The auto scaler compares current metric values against predefined thresholds, which can be configured through scaling parameters. These thresholds may specify conditions such as CPU utilization exceeding, for example, 50%, memory usage above certain limits, or custom metrics like message consumer lag exceeding a specified number of messages. If the metrics remain below the defined thresholds, the pod continues normal processing as described in step 502. The monitoring continues throughout the pod's lifecycle, enabling the system to detect and respond to workload changes.

At step 506, the system initiates a transformation process in response to metrics exceeding the threshold. The HOW controller detects the workload surge for the affected partition and triggers the primary pod's transition to an orchestrator role. For example, in a message broker implementation, when consumer lag exceeds 50 messages for a given partition, the primary pod processing that partition is triggered to transition into an orchestrator role.

During the role transition, the primary pod transforms from normal processing mode to orchestrator mode while maintaining its connection to the assigned partition. The pod exposes communication endpoints in this new role, which may use Google Remote Procedure Call (GRPC) or Representational State Transfer (REST) protocols.

The orchestrator pod takes on management responsibilities, including assigning offset ranges to newly spawned auxiliary pods and tracking task progress. These management functions enable the orchestrator pod to distribute workload efficiently and oversee processing status across all auxiliary pods.

At step 508, the auxiliary pod processing phase begins with auxiliary pod initialization. The auto scaler creates auxiliary pods to handle the increased workload. Upon initialization, each auxiliary pod contacts the orchestrator pod through a specific endpoint (e.g., /get-tasks) to request an offset range to process.

The orchestrator pod manages task assignments by allocating specific offset ranges from its partition to the auxiliary pods. This targeted assignment ensures each auxiliary pod has a distinct portion of the workload to process, preventing duplicate processing while maintaining ordered data handling.

During task execution, auxiliary pods consume and process data within their assigned offset ranges. Each auxiliary pod periodically reports its progress back to the orchestrator pod, enabling the orchestrator to maintain the current status of all processing tasks. The continuous feedback loop ensures the orchestrator pod can effectively monitor and manage the distributed processing workload.

At step 510, task completion and auxiliary pod termination begin when an auxiliary pod finishes processing its assigned offset range. The auxiliary pod notifies the orchestrator pod about completing its assigned tasks, providing the final status of all processed data within its assigned range.

Following task completion notification, the auxiliary pod initiates a graceful termination process by requesting permission from the orchestrator pod. Upon receiving termination approval, the auxiliary pod exits the system.

The orchestrator pod updates its internal state or the state store (e.g., Redis^{®} database or Apache Kafka^{®} topic) to mark the assigned offset range as processed, maintaining accurate records of completed work and ensuring no data processing gaps occur during the scaling process.

At step 512, system stabilization begins as workload levels decrease. During this phase, the system stops creating new auxiliary pods while existing ones complete their tasks and terminate. The orchestrator pod monitors the completion of all distributed tasks and updates the system state accordingly.

At step 514, in the role reversion phase, once all auxiliary pods have completed their tasks and the workload has stabilized, the orchestrator pod reverts to its original role as a primary pod. The system returns to the normal pod behavior at step 502, ready to respond to future workload changes.

While FIG. 5 shows a specific sequence of operations, this is a non-limiting example. Other implementations may include additional steps, different ordering, or varying mechanisms for threshold detection and auxiliary pod management based on specific deployment requirements and system characteristics.

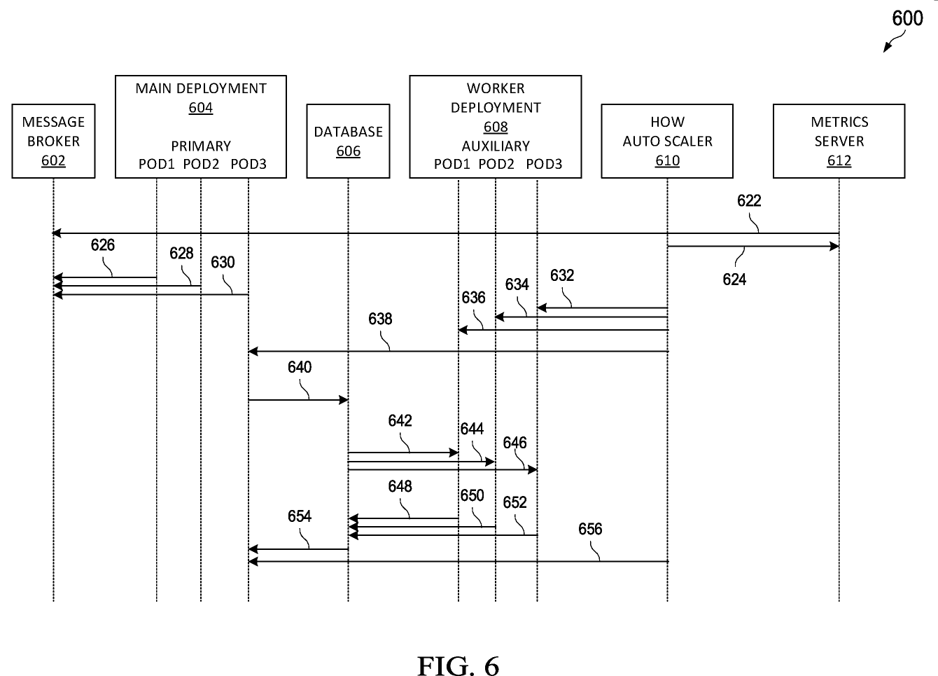

FIG. 6 illustrates a sequence diagram 600 showing an example interaction between components of the horizontally orchestrated auxiliary pod framework. The diagram shows message flow between a message broker 602, a main deployment 604 containing primary pods, a database 606, a worker deployment 608 containing auxiliary pods, a HOW auto scaler 610, and a metrics server 612, which may (or may not) be arranged as shown.

While FIG. 6 shows three primary pods and three auxiliary pods as an example implementation, this is a non-limiting example. Other implementations may employ different numbers of primary and auxiliary pods based on workload characteristics, resource availability, and scaling requirements.

At path 622, the metrics server 612 initiates a metrics collection operation by scraping performance and resource utilization data from the message broker 602. In an implementation, the message broker 602 is implemented as an Apache Kafka^{®}. These metrics can include message processing rates, consumer lag, partition assignments, and throughput measurements. In implementations, the metrics server 612 uses a pull-based model to periodically collect these metrics, storing them in, for example, an internal time-series database for analysis. This continuous monitoring enables the system to detect workload changes and trigger appropriate scaling responses.

At path 624, the HOW auto scaler 610 polls the metrics server 612 to obtain the collected metrics data. The auto scaler 610 continuously monitors these metrics to evaluate system performance and detect surge conditions. In implementations, the auto scaler 610 compares the polled metrics against predefined thresholds, which may include CPU utilization, memory usage, consumer lag, or custom metrics specific to the deployment. This polling mechanism enables the auto scaler 610 to make informed decisions about when to initiate the creation of auxiliary pods and trigger pod transformations based on current system conditions.

At paths 626, 628, and 630, the primary pods in the main deployment 604 read messages from their respective assigned partitions in the message broker 602. At path 626, a first primary pod (POD1) reads messages from a first partition, at path 628, a second primary pod (POD2) reads messages from a second partition, and at path 630, a third primary pod (POD3) reads messages from a third partition.

Each primary pod maintains a dedicated connection to its assigned partition, enabling independent processing of data streams. In implementations, this partition-aware message consumption ensures ordered processing within each partition while allowing parallel processing across different partitions.

At paths 632, 634, and 636, the system responds to a surge condition detected in the third partition. The HOW auto scaler 610, having detected that the load on partition 3 for the third primary pod (POD3) has crossed a defined threshold, initiates the creation of auxiliary pods.

At path 636, the HOW auto scaler 610 creates a first auxiliary pod (APOD1), a second auxiliary pod (APOD2), and a third auxiliary pod (APOD3) in the worker deployment 608. These auxiliary pods are created to handle the increased workload from the third primary pod's partition, enabling distributed processing while maintaining partition awareness. In implementations, this targeted creation of auxiliary pods allows the system to scale resources rather than scaling the entire deployment.

At path 638, the HOW auto scaler 610 transmits a transformation instruction to the third primary pod (POD3) in the main deployment 604, signaling it to transition from normal processing mode to orchestrator mode. This transition instruction is sent after the auto scaler has created the auxiliary pods and before task distribution begins.

In implementations, this transformation allows the third primary pod to maintain its connection to the third partition while changing its behavior from direct message processing to task orchestration. The transition enables the pod to take on management responsibilities for coordinating work across the newly created auxiliary pods while ensuring continuous data reception from its assigned partition.

At path 640, after transitioning to orchestrator mode, the third primary pod (POD3) publishes a task list to the database 606. This task list comprises processing work divided into specific ranges or portions from the third partition's workload. In implementations, the orchestrator pod generates these tasks based on the messages it continues to receive from its partition. However, instead of processing them directly, it creates discrete work units that can be distributed to the auxiliary pods. The database 606 serves as the central coordination point for task management, maintaining the list of available tasks and their processing status.

At paths 642, 644, and 646, the auxiliary pods in the worker deployment 608 read their assigned tasks from the database 606. The first auxiliary pod (APOD1) reads its assigned tasks at path 642, the second auxiliary pod (APOD2) reads its assigned tasks at path 644, and the third auxiliary pod (APOD3) reads its assigned tasks at path 646.

In implementations, each auxiliary pod independently fetches its work assignment from the task list published by the orchestrator pod. This decoupled task distribution mechanism can allow auxiliary pods to process portions of the third partition's workload without directly communicating with the message broker or participating in partition rebalancing operations. The database 606 can facilitate this coordination by providing a task assignment and tracking interface.

At paths 648, 650, and 652, the auxiliary pods report task completion status back to the database 606. The first auxiliary pod (APOD1) indicates completion of its assigned tasks at path 648, the second auxiliary pod (APOD2) reports completion at path 650, and the third auxiliary pod (APOD3) signals completion at path 652.

In implementations, each auxiliary pod updates the database 606 after processing its assigned workload portion, marking its tasks as completed. This completion reporting enables the orchestrator pod to track processing progress and ensure all distributed tasks are properly executed. The database 606 maintains these completion records, providing a reliable mechanism for monitoring the overall progress of workload processing across all auxiliary pods.

At path 654, the third primary pod (POD3), operating in orchestrator mode, reads the task progress information from database 606 to determine if all distributed tasks have been completed by the auxiliary pods.

In implementations, the orchestrator pod monitors the completion status of all previously delegated tasks, checking whether each auxiliary pod has successfully processed its assigned portion of the workload. This progress monitoring enables the orchestrator pod to oversee the distributed processing operation and determine when all tasks from its partition have been processed. Once all tasks are confirmed complete, the orchestrator pod can prepare to transition back to its normal processing role.

At path 656, after confirming all tasks have been completed, the HOW auto scaler 610 sends an instruction to the third primary pod (POD3) to revert from orchestrator mode back to normal pod operating mode.

In implementations, this transition instruction is sent after verifying that all auxiliary pods have completed their assigned tasks and updated their status in the database 606. This controlled reversion ensures that no tasks are left unprocessed during the transition. Upon receiving this instruction, the third primary pod can resume direct processing of messages from its assigned partition, returning the system to its original processing state while maintaining partition awareness and processing continuity.

The horizontally orchestrated auxiliary pod framework provides several benefits over existing scaling approaches. A primary advantage is continuous processing capability, where the system maintains uninterrupted message processing by eliminating the need for pod restarts or partition rebalancing operations. This approach ensures zero downtime during scaling events, as the primary pod continues to receive messages while transitioning to and from orchestrator mode.

The framework achieves superior resource efficiency through dynamic auxiliary pod management. Auxiliary pods exist during periods of high load and are terminated once their tasks are completed, preventing idle resource consumption. This targeted scaling approach ensures computing resources are utilized, optimizing system resource allocation.

Partition-aware scaling provides another benefit of the framework. Auxiliary pods handle specific offset ranges within a partition, eliminating the need for partition rebalancing that typically occurs in traditional scaling approaches. This enables efficient processing while maintaining partition awareness, ensuring ordered message processing without the overhead of partition reassignment.

The framework enables seamless role transitions for affected pods. Primary pods can dynamically transform into orchestrators and revert to normal processing mode once the workload stabilizes. This flexibility allows the system to adapt to changing workload conditions while maintaining processing continuity and partition assignments.

Cost efficiency is achieved through resource allocation and management. The system scales horizontally by creating auxiliary pods and terminates them promptly after task completion. This approach prevents resource wastage during idle periods and optimizes infrastructure costs by maintaining the minimum processing capacity at any given time.

While FIG. 6 shows specific message flows and component interactions, this is a non-limiting example. Other implementations may include additional interactions, different ordering, or varying mechanisms for communication between components based on specific deployment requirements and system characteristics.

The choice between vertical pod autoscaling (VPA), horizontal pod autoscaling (HPA), and the horizontally orchestrated auxiliary pod framework can depend on specific workload characteristics and system requirements. The decision criteria include workload persistence, partition awareness requirements, state maintenance needs, and performance impact tolerance.

VPA may be implemented when historical analysis shows persistent resource pressure across all pods in a deployment, requiring increased CPU and memory allocations. For example, when monitoring indicates that the entire deployment consistently operates near resource limits, VPA can adjust specifications for all pods to better match long-term resource demands. This approach can be particularly suitable in scenarios such as database pods requiring increased memory for growing datasets, processing pods handling increasingly complex computations, or applications whose resource requirements have evolved beyond their initial specifications. However, VPA's requirement to restart pods makes it less suitable for scenarios requiring continuous processing or maintaining a partition state.

In contrast, HPA may be implemented when workload increases can be effectively distributed across multiple replica pods that do not require partition awareness. For example, in stateless applications or when pods can independently process requests from any source, HPA can scale the number of pods to handle increased load while maintaining system performance. Common scenarios include web server pods handling increased HTTP requests, API gateway pods managing traffic spikes, or computation pods processing parallel workloads. The consideration for HPA implementation is that the workload is divisible across multiple identical pods without concern for state maintenance or partition assignment.

The horizontally orchestrated auxiliary pod framework described herein may be implemented when surge conditions affect specific partition-aware pods while others operate normally. This approach is particularly suitable when workload increases are temporary and partition awareness is maintained.

For example, when a specific partition experiences a surge in message volume while other partitions maintain normal processing rates, the framework enables targeted scaling without disrupting the entire deployment or triggering partition rebalancing operations. This framework excels in scenarios such as message broker consumers handling partition-specific traffic spikes, stream processing applications with partition-aware state maintenance, or any situation where maintaining processing continuity for specific data streams is critical while managing temporary workload increases.

The selection between these scaling approaches often involves evaluating multiple factors in combination. System administrators and automated management systems can consider workload patterns, resource utilization trends, partition awareness requirements, state maintenance needs, and acceptable performance impact when choosing the appropriate scaling strategy. In some implementations, different scaling approaches may be used for different components within the same system, based on their specific requirements and characteristics.

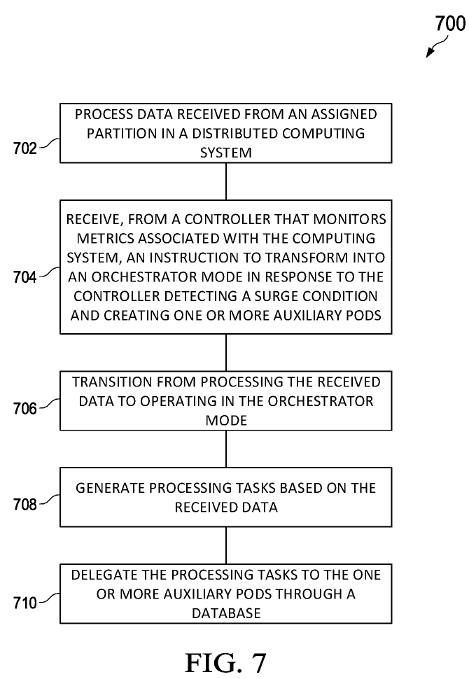

FIG. 7 illustrates a flowchart of an implementation method 700 for operations performed by a computing system processing data as a primary pod in a distributed computing environment. It is noted that all steps outlined in the method are not necessarily required and can be optional. Further, changes to the arrangement of the steps, removal of one or more steps and path connections, and addition of steps and path connections are similarly contemplated.

At step 702, the primary pod processes data received from an assigned partition in a distributed computing system. In implementations, the distributed computing system includes one or more containers that share networking and storage resources within a computing node. During this step, the primary pod operates as, for example, part of a message broker consumer group, directly processing messages from its assigned partition.

At step 704, the primary pod receives instructions from a controller to transform into orchestrator mode. In implementations, the instruction is sent in response to the controller detecting a surge condition through monitoring metrics associated with the computing system and creating one or more auxiliary pods to handle the increased workload. The auxiliary pods are configured to operate independently from the message broker consumer group, preventing partition reassignment and rebalancing during scaling operations.

At step 706, the primary pod transitions from processing the received data to operating in the orchestrator mode. During this transition, the primary pod maintains its connection to the assigned partition while exposing communication endpoints for managing the auxiliary pods. These communication endpoints enable the primary pod to coordinate task distribution and monitor processing progress across the auxiliary pods.

At step 708, the primary pod generates processing tasks based on the received data. The tasks can be created from the partition data, with the database serving as a state store to track task assignments, maintain offset information, and store processing progress data. The state store maintains the relationship between specific tasks and their assigned auxiliary pods.

At step 710, the primary pod delegates the processing tasks to the auxiliary pods through a database. The database can maintain state information between the primary pod and auxiliary pods, enabling task distribution and progress tracking. The primary pod receives task completion notifications from the auxiliary pods and updates the processing status in the database accordingly, ensuring accurate tracking of all distributed work.

While FIG. 7 shows specific steps in the operation and transformation of a primary pod, this is a non-limiting example. Other implementations may include additional steps, different ordering, or varying task generation and delegation mechanisms based on specific deployment requirements and system characteristics.

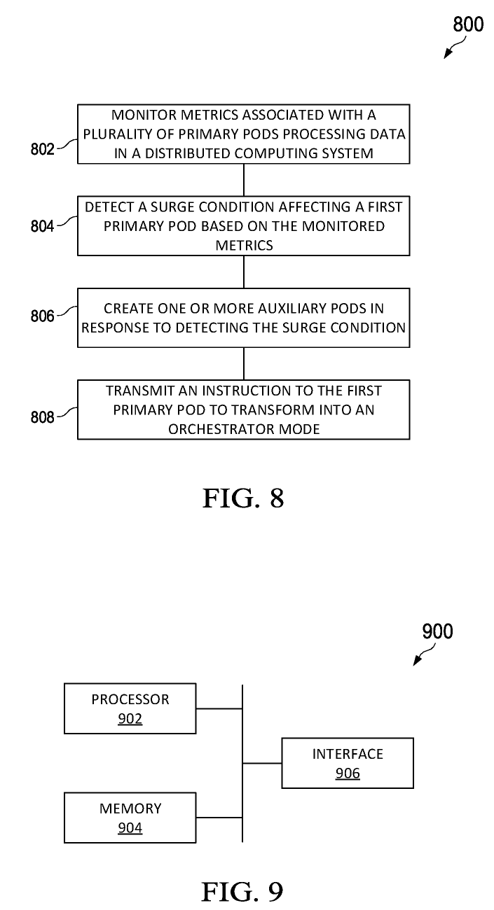

FIG. 8 illustrates a flowchart of an implementation method 800 for operations performed by a computing system functioning as a controller in a distributed computing environment. It is noted that all steps outlined in the method are not necessarily required and can be optional. Further, changes to the arrangement of the steps, removal of one or more steps and path connections, and addition of steps and path connections are similarly contemplated.

At step 802, the computing system monitors metrics associated with a plurality of primary pods processing data in a distributed computing system. Each primary pod can include one or more containers that share networking and storage resources within a computing node. In implementations, the monitored metrics include CPU utilization, memory usage, throughput measurements, consumer lag, or combinations thereof. The monitoring includes collecting these performance metrics, resource utilization data, and processing statistics from the primary pods.

At step 804, the computing system detects a surge condition affecting a first primary pod based on the monitored metrics. The detection involves comparing the current metric values against predefined thresholds to identify when processing demands exceed normal operating parameters for the first primary pod. In implementations, these thresholds can be configured based on specific workload characteristics and system capabilities.

At step 806, the computing system creates one or more auxiliary pods in response to detecting the surge condition. These auxiliary pods are created to handle the increased workload from the affected primary pod while maintaining independent operation from the message broker consumer group to prevent partition reassignment and rebalancing operations. The computing system verifies the establishment of communication between the first primary pod and the auxiliary pods through the database.

At step 808, the computing system transmits instructions to the first primary pod to transform into an orchestrator mode. Upon receiving this instruction, the first primary pod transitions from processing the received data to operating in the orchestrator mode, where it generates processing tasks based on the received data and delegates these tasks to the auxiliary pods through a database. The computing system monitors the task delegation process from the first primary pod to the auxiliary pods, tracking task assignments and completion status. When the auxiliary pods complete their assigned tasks and update their processing state in the database, the computing system terminates the auxiliary pods.

While FIG. 8 shows specific steps in controlling and managing pod scaling operations, this is a non-limiting example. Other implementations may include additional steps, different ordering, or varying mechanisms for monitoring and managing pod transformations based on specific deployment requirements and system characteristics.

FIG. 9 illustrates a block diagram of an implementation computing system 900 that can implement the primary pods, auxiliary pods, and controller components described herein. The computing system 900 includes a processor 902, a memory 904, and an interface 906, which may (or may not) be arranged as shown. Computing system 900 may include additional components not shown, such as power management circuitry.

Processor 902 can be implemented as one or more processing units that execute instructions to perform the operations and functionality described herein. In implementations, processor 902 can execute instructions to perform, for example, operations of a primary pod processing data from an assigned partition, an auxiliary pod processing delegated tasks, or a controller managing pod transformations and scaling operations in the distributed computing system.

Memory 904 can be implemented as a non-transitory memory storage comprising computer-readable storage media for storing instructions. When the stored instructions are executed by processor 902, they cause the computing system 900 performs the operations and functions of the primary pods, auxiliary pods, and controller components described in the implementations above. The memory 904 can also store operational data, configuration parameters, and state information used during execution of the instructions.

Interface 906 enables communication between the computing system 900 and other components in the distributed computing environment. In implementations, interface 906 can facilitate communication with message brokers, metrics servers, databases, and other pods through various communication protocols and APIs, as described in the implementations above.

While FIG. 9 shows specific components of a computing system, this is a non-limiting example. Other implementations may include additional components, different arrangements, or varying mechanisms for implementing the processing and communication functionality described herein.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A computer-implemented method, comprising:
monitoring metrics associated with a plurality of primary pods processing data in a distributed computing system, wherein each primary pod comprises one or more containers that share networking and storage resources within a computing node;
detecting a surge condition affecting a first primary pod based on the monitored metrics;
creating one or more auxiliary pods in response to detecting the surge condition;
transforming the first primary pod into an orchestrator pod;
receiving, by the first primary pod, data from an assigned partition;
generating, by the first primary pod, processing tasks based on the data; and
delegating, by the first primary pod, the processing tasks to the one or more auxiliary pods through a database.

2. The method of claim 1, wherein the metrics comprise CPU utilization, memory usage, throughput measurements, consumer lag, or a combination thereof.

3. The method of claim 1, wherein detecting the surge condition comprises comparing the monitored metrics against predefined thresholds.

4. The method of claim 1, wherein transforming the first primary pod comprises:
exposing communication endpoints for managing the one or more auxiliary pods; and
maintaining a connection to the assigned partition.

5. The method of claim 1, further comprising:
maintaining, by the database, state information between the first primary pod and the one or more auxiliary pods; and
enabling, by the database, task distribution and progress tracking.

6. The method of claim 1, further comprising:
receiving task completion notifications from the one or more auxiliary pods; and
updating processing status in the database.

7. The method of claim 1, wherein the processing tasks comprise offset ranges within the assigned partition.

8. A computing system implementing a primary pod for processing data in a distributed computing system, the computing system comprising:
a non-transitory memory storage comprising instructions; and
a processor coupled to the non-transitory memory storage, wherein the processor executes the instructions to:
process data received from an assigned partition in the distributed computing system, wherein the computing system comprises one or more containers that share networking and storage resources within a computing node,
receive, from a controller that monitors metrics associated with the computing system, an instruction to transform into an orchestrator mode in response to the controller detecting a surge condition and creating one or more auxiliary pods,
transition from processing the data to operating in the orchestrator mode,
generate processing tasks based on the data, and
delegate the processing tasks to the one or more auxiliary pods through a database.

9. The computing system of claim 8, wherein the processor executes the instructions to expose communication endpoints for managing the one or more auxiliary pods in response to the primary pod operating in the orchestrator mode.

10. The computing system of claim 9, wherein state information between the primary pod and the one or more auxiliary pods are maintained in the database, and wherein task distribution and progress tracking are enabled by the database.

11. The computing system of claim 8, wherein the processor executes the instructions to maintain a connection to the assigned partition while operating in the orchestrator mode.

12. The computing system of claim 8, wherein the processor executes the instructions to:
receive task completion notifications from the one or more auxiliary pods; and
update processing status in the database.

13. The computing system of claim 8, wherein the one or more auxiliary pods operate independently from a message broker consumer group to prevent partition reassignment and rebalancing during scaling operations.

14. The computing system of claim 8, wherein the database comprises a state store to track task assignments, maintain offset information, store processing progress data, or a combination thereof.

15. A computing system implementing a controller, the computing system comprising:
a non-transitory memory storage comprising instructions; and
a processor coupled to the non-transitory memory storage, wherein the processor executes the instructions to:
monitor metrics associated with a plurality of primary pods processing data in a distributed computing system, wherein each primary pod comprises one or more containers that share networking and storage resources within a computing node,
detect a surge condition affecting a primary pod based on the monitored metrics,
create one or more auxiliary pods in response to detecting the surge condition, and
transmit an instruction to the primary pod to transform into an orchestrator mode, wherein the primary pod transitions from processing data to operating in the orchestrator mode in response to receiving the instruction, wherein the primary pod generates processing tasks based on the data, and wherein the primary pod delegates the processing tasks to the one or more auxiliary pods through a database.

16. The computing system of claim 15, wherein the metrics comprise CPU utilization, memory usage, throughput measurements, consumer lag, or a combination thereof.

17. The computing system of claim 15, wherein detecting the surge condition comprises comparing the monitored metrics against predefined thresholds.

18. The computing system of claim 15, wherein the processor executes the instructions to verify establishment of communication between the primary pod and the one or more auxiliary pods through the database.

19. The computing system of claim 15, wherein the processor executes the instructions to monitor task delegation from the primary pod to the one or more auxiliary pods.

20. The computing system of claim 15, wherein the processor executes the instructions to terminate the one or more auxiliary pods in response to:
the auxiliary pods completing their assigned tasks;
the auxiliary pods updating processing state in the database; and
the auxiliary pods terminating.
